(19) United States
(12) Patent Application Publication
(10) Pub. No.: US 2019/0162375 A1
(43) Pub. Date: May 30, 2019

(54) ELECTRONIC CANDLE

(71) Applicant: Changsha Pretty Home Deco Lighting Co., Ltd, Changsha County (CN)

(72) Inventor: Ziming SHU, Changsha (CN)

(21) Appl. No.: 15/977,577

(22) Filed: May 11, 2018

Related U.S. Application Data
(63) Continuation of application No. PCT/CN2018/071471, filed on Jan. 5, 2018.

(30) Foreign Application Priority Data
Nov. 30, 2017 (CN) 201721637294.4

(51) Int. Cl. F21S 6/00; F21S 10/04; F21V 15/01

(52) U.S. Cl. CPC F21S 6/001; F21W 2121/00; F21V 15/01; F21S 10/04

(57) ABSTRACT

In some embodiments, an electronic candle includes a housing having a first through hole. The electronic candle includes a flame piece, a flame piece holder, a mounting seat, a light emitting member, and a circuit board. The flame piece and the flame piece holder are placed on the housing. The mounting seat is placed in an inner cavity of the housing. A top portion of the mounting seat includes a second through hole. The circuit board and the light emitting member are placed on the mounting seat. The top portion of the mounting seat and the first through hole are connected. The flame piece holder is coupled to the mounting seat. The flame piece holder includes a cantilever seat fixedly connected with an inner wall of the second through hole.

### CROSS-REFERENCE TO RELATED APPLICATIONS

This application is a continuation of International Application Serial No. PCT/CN2018/071471, filed on Jan. 5, 2018, and entitled “An Electronic Candle,” which claims priority to the Chinese Patent Application No. 201721637294.4, filed on Nov. 30, 2017, and entitled “An Electronic Candle.” The contents of the above-referenced patent applications are incorporated herein by reference in their entirety.

### BACKGROUND

Some embodiments described herein relate generally to an electronic candle.

Known electronic candle structure includes a base, a housing, a flame piece, a flame piece holder, a mounting seat, a light emitting member, a coil, and a circuit board. The flame piece can oscillate to simulate the effect of a candle. The existing structure has at least the following deficiencies.

First, the known candle structure is composed of a large number of small components. The flame piece holder itself is only a single small piece among these components. When the electronic candle is assembled manually, the flame piece holder is assembled on the mounting seat first, and then the flame piece can be hung on the flame piece holder. In this process, the installation space within the mounting seat is limited and smaller than the size of a human finger, resulting in the manual assembly by workers inconvenient. The flame piece has to be tried many times before it can be placed in the right place, which greatly reduces the assembly efficiency.

Second, in the known candle structure, the flame piece is in surface contact with the flame piece holder. In some known candle structures, the flame piece holder includes a spherical groove and the flame piece includes a spherical support portion. The spherical support portion is in close fit with the spherical groove, thus allowing the spherical support portion to oscillate within the spherical groove. The oscillation of the spherical support portion enables the flame piece to oscillate to simulate the candle effect. However, due to the surface contact between the spherical support portion and the spherical groove, it has been found during actual use that the oscillation of the flame piece was not as flexible as desirable.

Third, in the known candle structure, the coil and the circuit board are two separate components and are separately arranged on the mounting seat. Two wire ends, extending from the coil, are soldered to the circuit board, respectively. When the wire ends are soldered to the circuit board, the wires are connected to different positions of the mounting seat. It is easy to break the wire because each wire of the coil is thin. It can result in a breakage of the wire or de-soldering of the wires from the circuit board. Such design is problematic for the manual assembly process, reducing the quality product rate and assembly efficiency.

Accordingly, a need exists for an electronic candle with an improved assembly process and a flame piece that moves flexibly to simulate the effect of a traditional non-electronic candle.

### SUMMARY

In some embodiments, an electronic candle includes a having a first through hole. The electronic candle includes a flame piece, a flame piece holder, a mounting seat, a light emitting member, and a circuit board. The flame piece and the flame piece holder are placed on the housing. The mounting seat is placed in an inner cavity of the housing. A top portion of the mounting seat includes a second through hole. The circuit board and the light emitting member are placed on the mounting seat. The top portion of the mounting seat and the first through hole are connected. The flame piece holder is coupled to the mounting seat. The flame piece holder includes a cantilever seat fixedly connected with an inner wall of the second through hole. A front end of the cantilever seat includes a groove. The bottom of the groove is a flat surface.

### BRIEF DESCRIPTION OF THE DRAWINGS

FIG. 1 is an schematic illustration of an electronic candle, according to an embodiment.

FIG. 2 is an schematic illustration of a side view (A-A view) of the electronic candle.

FIG. 3 is an schematic illustration of a side view (B-B view) of the electronic candle.

FIG. 4 is an schematic illustration of an exterior view of a mounting seat and a flame piece in the housing of the electronic candle.

FIG. 5 is an schematic illustration of a side view of the mounting seat while unassembled.

FIG. 6 is an schematic illustration of a side view of the mounting seat while unassembled.

FIG. 7 is an schematic illustration of the flame piece and the mounting seat

FIG. 8 is an schematic illustration of the flame piece.

FIG. 9 is an schematic illustration of a top view of the housing of the electronic candle.

### DETAILED DESCRIPTION

Some embodiments described herein include an electronic candle, which includes a base, a housing mounted on the base, a first through hole on the housing, a flame piece, a flame piece holder, a hollow mounting seat within an inner cavity of the housing, a light emitting member mounted on the mounting seat, a circuit board mounted on the mounting seat, a second through hole on a top portion of the mounting seat, a fixture to connect the top portion of the mounting seat and the first through hole. The flame piece holder is coupled to the mounting seat. In other words, the flame piece holder and the mounting seat are formed as a single unit. The flame piece holder includes a cantilever seat fixedly connected with an inner wall of the second through hole. The cantilever seat can be in a horizontal direction. A front end of the cantilever seat includes a groove and the bottom of the groove is a flat surface.

The flame piece includes a flame body and a support portion placed at the lower portion of the flame body. The support portion has an inverted conical body. The lower portion of the support portion is placed at the bottom of the groove of the cantilever seat. The flame body protrudes from the second through hole.

The electronic candle includes a driving device placed right below the flame piece to drive the flame piece to move flexibly to simulate the effect of a traditional non-electronic candle. The light emitting member is placed on one side of the flame piece and can be configured to project light onto the flame body;

The circuit board is operatively and electrically connected to the driving device and the light emitting member.

In these embodiments, the flame piece holder is coupled to (e.g., monolithically or integrally) formed with the mounting seat, which eliminates the assembly steps of the flame piece holder and the mounting seat. In other words, the flame piece holder and the mounting seat are formed as a single unit. No extra steps are needed to assembly the flame piece holder and the mounting seat. The assembly steps includes hanging the flame piece on the cantilever seat, which makes manual assembly process more convenient and efficient.

In these embodiments, the support portion of the flame piece is in point contact with the groove of the cantilever seat. The contact point between the flame piece and the groove of the cantilever seat is smaller than that of the known candle structure. The known candle structure has a surface contact between the flame piece and the flame piece holder. The oscillation of the flame piece is more flexible than that of the known candle structure.

The flame piece includes a permanent magnet placed directly below the support portion. The flame piece includes a connection ring connecting the flame body and the permanent magnet. The support portion of the flame piece is placed within the connection ring. An air gap exists between the lower end of the support portion and the permanent magnet.

The driving device includes the coil electrically connected to the circuit board. The coil is placed below the permanent magnet. The driving device is configured to drive the flame piece to oscillate due to the electromagnetic induction. When the coil is connected to a power source and current flows through the coil, a magnetic field is generated. The permanent magnet is oscillated by the magnetic force generated by the magnetic field, causing the flame body to oscillate.

The coil is integrated and fixed on the circuit board. When the wire ends are soldered to the circuit board of the known candle structure, the wires are connected to different positions of the mounting seat. It is easy to break the wire in the known candle structure because each wire of the coil is thin, which can result in a breakage of the wire or de-soldering of the wires from the circuit board. The embodiments described herein allow the coils to be integrated and fixed to the circuit board. Thus, in the assembly process, there is no extra step to attach the coil on the circuit board, keeping the coil wires intact and not broken.

In some implementations, the lower portion of the mounting seat includes a slot and the circuit board can be inserted into the slot for stabilization and electrical connection.

In the embodiments described herein, the flame piece holder is monolithically formed with the mounting seat, thus eliminating the step of assembling these two parts. The flame piece can be placed (hung or suspended) on the cantilever seat, which is more convenient for manual assembly.

In the embodiment described herein, the support portion of the flame piece is in point contact with the groove of the cantilever seat. The contact point between the flame piece and the groove of the cantilever seat is smaller than that of the known candle structure. The oscillation of the flame piece is more flexible than that of the known candle structure.

In the embodiment described herein, the coil is integrated and fixed on the circuit board. In the following assembly process, the circuit board can be placed onto the mounting seat. There is no extra step to attach the coil on the circuit board, keeping the coil wires intact and not broken.

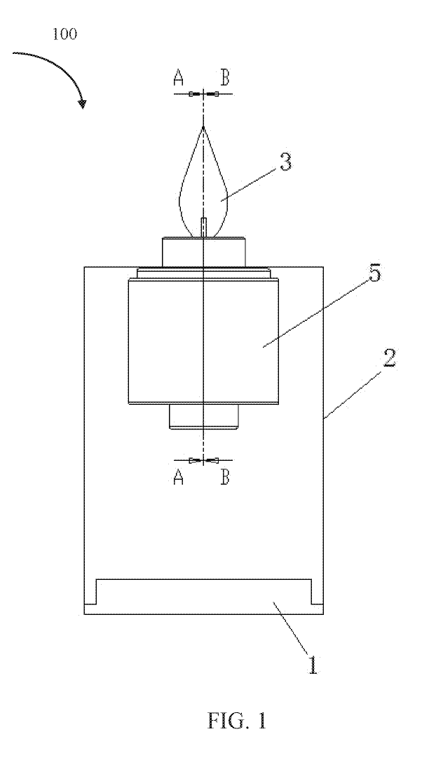

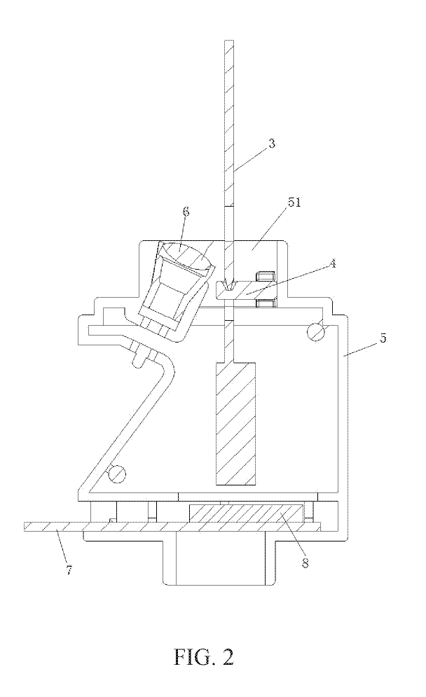

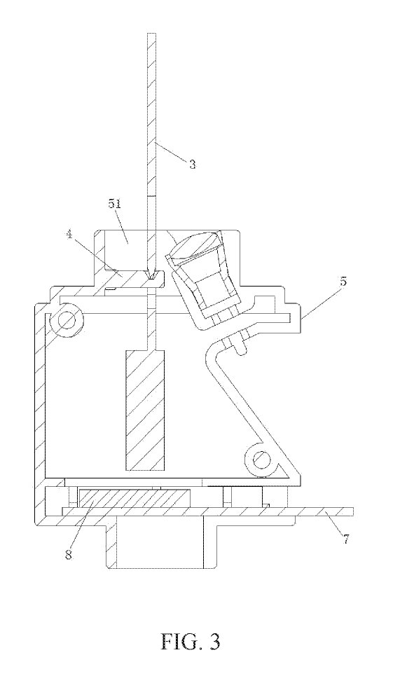

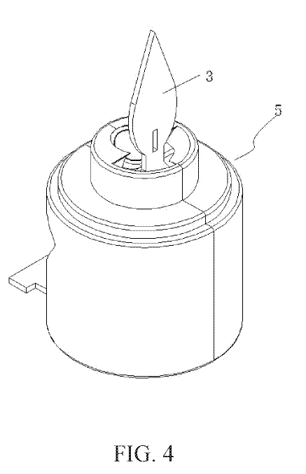

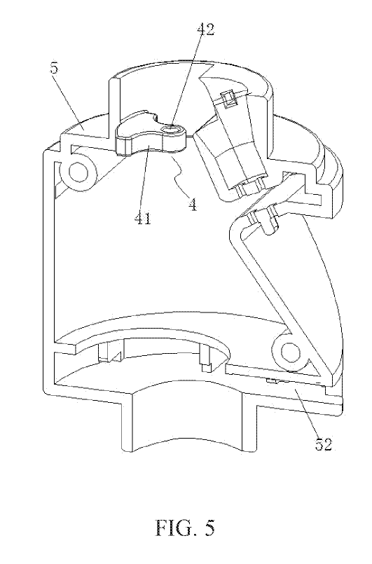

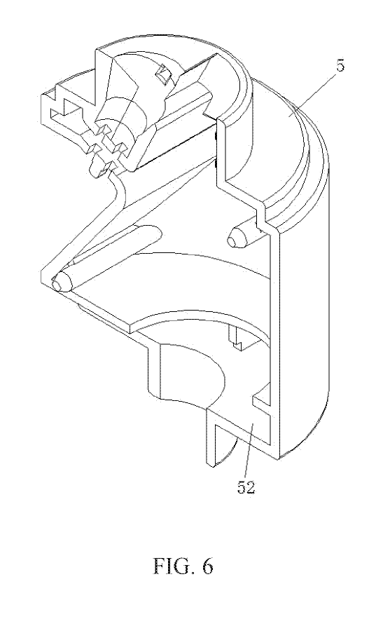

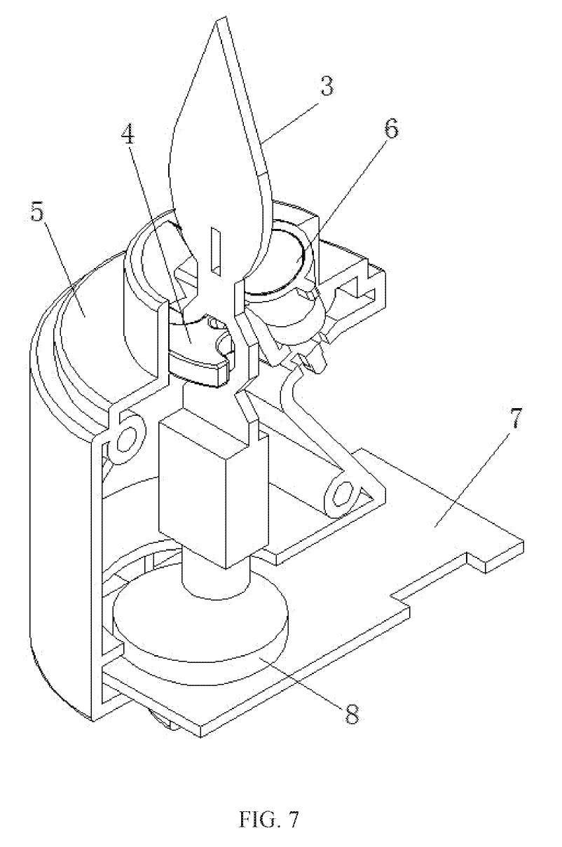

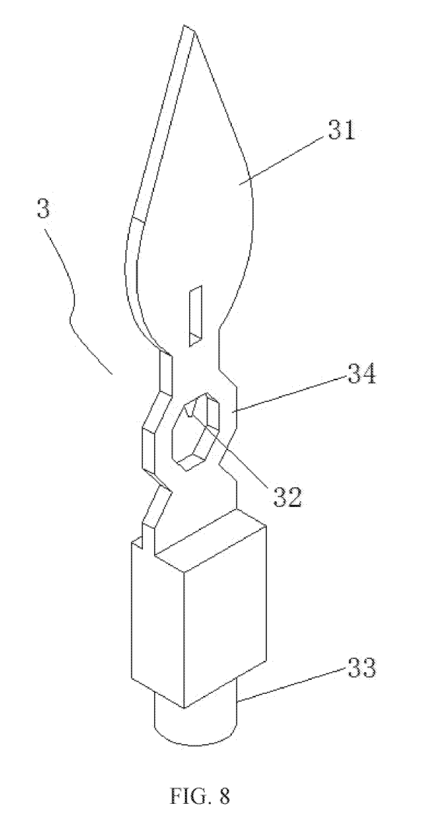

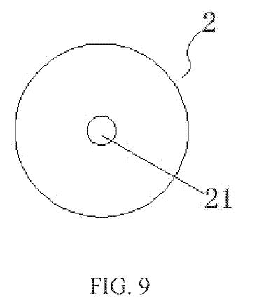

FIGS. 1-9 are schematic illustrations of an electronic candle, according to an embodiment. FIG. 1 is an schematic illustration of an electronic candle (100). FIG. 2 is an schematic illustration of a side view (A-A view) of the electronic candle of FIG. 1. FIG. 3 is an schematic illustration of a side view (B-B view) of the electronic candle of FIG. 1. FIG. 4 is an schematic illustration of internal components in the housing of the electronic candle of FIG. 1. FIG. 5 is an schematic illustration of a side view of the mounting seat of the electronic candle of FIG. 1. FIG. 6 is an schematic illustration of a side view of the mounting seat of the electronic candle of FIG. 1. FIG. 7 is an schematic illustration of a flame piece and the mounting seat of the electronic candle of FIG. 1. FIG. 8 is an schematic illustration of the flame piece of the electronic candle of FIG. 1. FIG. 9 is an schematic illustration of a top view of the housing of the electronic candle of FIG. 1.

As shown in FIGS. 1-9, the electronic candle (100) includes a base (1), a hollow housing (2) mounted on the base (1), a first through hole (21) on the housing (2), a flame piece (3), a flame piece holder (4). The flame piece (3) and the flame piece holder (4) are placed on a top portion of the housing (2). The electronic candle includes a hollow mounting seat (5) disposed within the inner cavity of the housing (2). The electronic candle includes a light emitting member (6) coupled to the mounting seat (5) and a circuit board (7) coupled to the mounting seat.

The top portion of the mounting seat (5) includes a second through hole (51). The top portion of the mounting seat (5) is aligned with the first through hole (21). The lower portion of the mounting seat (5) includes a card slot (52).

The flame piece holder (4) is monolithically formed with the mounting seat (5). The flame piece holder (4) includes a horizontal cantilever seat (41) fixedly connected with an inner wall of the mounting seat (5) at the position of the second through hole (51). The front end of the cantilever seat (41) includes a groove (42). The bottom of the groove (42) is a substantially flat surface.

The flame piece (3) includes a flame body (31) and a support portion (32) placed at the lower end of the flame body (31). The support portion (32) has an inverted conical body. When disposed within the mounting seat (5), the lower end of the support portion (32) is placed at the bottom of the groove (42) and the flame body (31) protrudes from the second through hole (51). In other words, a first portion of the flame body (31) is disposed above the second through hole (51) and a second portion of the flame body (31) is disposed within the second through hole (51). The flame piece (3) further includes a permanent magnet (33) placed in the lower portion of the flame piece (3) and below the support portion (32). The flame piece (3) includes a connection ring (34) connecting the flame body (31) and the permanent magnet (33). The support portion (32) is placed within the connection ring (34), and an air gap exists between the lower end of the support portion (32) and the permanent magnet (33). The flame body (31) has a portion above the first through hole (21).

Below (or immediately below) the flame piece (3) is a driving device for driving the flame piece (3) to oscillate. The drive device includes a coil (8), the permanent magnet (33), and the circuit board (7). The coil (8) can be electrically connected to the circuit board (7). The coil (8) is placed below (or directly below) the permanent magnet (33). The coil (8) is integrally fixed on the circuit board (7). The circuit board (7) can be inserted into the slot (52).

The circuit board (7) is electrically connected to the coil (8) and the light emitting member (6). The light emitting member (6) is placed on one side of the flame piece (3) and is configured to project light onto the flame body (31). The light emitting member (6) can be, for example, an light-emitting diode (LED) light.

1. An electronic candle, comprising:
a housing including a first through hole;
a flame piece;
a flame piece holder, the flame piece and the flame piece holder placed on the housing;
a light source placed on a mounting seat; and
the mounting seat placed in an inner cavity of the housing, a top portion of the mounting seat including a second through hole,
the top portion of the mounting seat and the first through hole being connected, the flame piece holder coupled to the mounting seat, the flame piece holder including a cantilever seat fixedly connected with an inner wall of the second through hole, a front end of the cantilever seat including a groove,
the flame piece includes a flame body and a support portion disposed at a lower portion of the flame piece,
the support portion includes an inverted conical body,
a lower end of the support portion is placed at a bottom portion of the groove, and
the flame body having a first portion disposed within the second through hole and a second portion disposed above the second through hole.

2. (canceled)

3. The electronic candle of claim 1, wherein:
the light source is placed on the mounting seat to one side of the flame piece, the light source is configured to project light onto the flame body.

4. The electronic candle of claim 3, further comprising:
a driving device placed below the flame piece, the driving device configured to oscillate the flame piece.

5. The electronic candle of claim 4, further comprising:
a circuit board electrically connected to the driving device and the light source.

6. The electronic candle of claim 5, wherein:
the flame piece includes a permanent magnet disposed in a lower end of the flame piece, the support portion being disposed between the flame body and the permanent magnet,
the flame piece includes a connection ring connecting the flame body and the permanent magnet, and
the support portion is placed within the connection ring.

7. The electronic candle of claim 6, wherein:
the flame piece includes a gap between the lower end of the support portion and the permanent magnet.

8. The electronic candle of claim 7, wherein:
the driving device includes a coil electrically connected to the circuit board, the coil placed below the permanent magnet.

9. The electronic candle of claim 8, wherein:
the coil is integrally fixed on the circuit board.

10. The electronic candle of claim 9, wherein:
a lower portion of the mounting seat includes a slot,
the circuit board is placed into the slot.

11. An electronic candle holder, comprising:
a housing including a first through hole;
a flame piece;
a flame piece holder, the flame piece and the flame piece holder placed on the housing; and
a mounting seat placed in an inner cavity of the housing, a top portion of the mounting seat including a second through hole,
the top portion of the mounting seat and the first through hole being connected, the flame piece holder coupled to the mounting seat and including a cantilever seat, the cantilever seat coupled to the second through hole and including a groove,
the flame piece includes a flame body and a support portion disposed at a lower portion of the flame piece,
the support portion includes an inverted conical body,
a lower end of the support portion is placed at a bottom portion of the groove, and
the flame body having a first portion disposed within the second through hole and a second portion disposed above the second through hole.
